(19) United States
(12) Patent Application Publication
(10) Pub. No.: US 2010/0271276 A1
(43) Pub. Date: Oct. 28, 2010

(54) ANTENNA IN WHICH SQUINT IS IMPROVED

(75) Inventors: Seung-Chul Lee, Busan (KR); Phil-Soo Shin, Incheon (KR)

Correspondence Address: EDWARDS ANGELL PALMER & DODGE LLP, P.O. BOX 55874, BOSTON, MA, 02205, US

(73) Assignee: ACE ANTENNA CORPORATION, Incheon (KR)

(21) Appl. No.: 12/681,531

(22) PCT Filed: Oct. 19, 2007
(86) PCT No.: PCT/KR07/05137

§ 371 Date: Apr. 2, 2010

(30) Foreign Application Priority Data
Oct. 5, 2007 (KR) 10-2007-0100540

(51) Int. Cl. H01Q 21/06

(52) U.S. Cl. 343/742

(57) ABSTRACT

An antenna for improving squint using radiation devices having different kind is disclosed. The antenna includes at least two radiation devices configured to have a beam pointing line, respectively. Here, kind of one or more of the radiation devices has different from that of the other radiation device.

### TECHNICAL FIELD

Example embodiment of the present invention relates to an antenna of which squint is improved, more particularly relates to an antenna for improving squint using radiation devices having different kind.

### BACKGROUND ART

A radiation device included in an antenna transmits/receives an electromagnetic wave by outputting a certain radiation pattern, and has structure shown in below FIG. 1.

FIG. 1 is a plan view illustrating a radiation device included in a common antenna. FIG. 2 is a view illustrating squint occurred in the radiation device in FIG. 1.

In FIG. 1, the radiation device has a plurality of dipole devices 100, 102, 104 and 106 and a feeding section 108, and generates +45° polarization and −45° polarization. Here, the dipole members 100, 102, 104 and 106 and the feeding section 108 are disposed on a reflection plate (not shown). Hereinafter, only +45° polarization will be considered for describing operation of the antenna for convenience of description.

The feeding section 108 includes a first feeding point 110A, a second feeding point 110B, a third feeding point 110C and a fourth feeding point 110D.

Current inputted to the first feeding point 110A is applied to the first dipole member 100 and the fourth dipole member 106, and is applied to the second dipole member 102 and the three dipole member 104 through the third feeding point 110C.

Current inputted to the second feeding point 110B is applied to the first dipole member 100 and the second dipole member 102, and is provided to the third dipole member 104 and the fourth dipole member 106 through the fourth feeding point 110D. As a result, the electric fields generated by the current passing to the dipole members 100, 102, 104 and 106 are synthesized through a vector composition method, thereby generating a radiation pattern 200 as shown in FIG. 2. Here, the radiation pattern 200 is a pattern when tilt of a beam radiated from the radiation device included in the antenna is 0°, i.e. when Θ is 0°.

In this antenna, the tilt of the beam is changed into for example −15° as shown in FIG. 2, a center of the radiation pattern 200 should be ideally moved along a beam pointing line 202 formed along a Θ axis. That is, in case that the tilt of the beam is changed by 15°, a center of the radiation pattern 204 should be located at the beam pointing line 202. Here, the beam pointing line means a moving path of the center of the radiation pattern 200 when the tilt of the beam is changed.

However, in case that the tilt of the beam is changed, the center of the radiation pattern 200 is not moved really along the beam pointing line 202, but is moved along new beam pointing line 208. In other words, the tilt of the beam is changed by 15°, a center of a radiation pattern 206 is really located at a beam pointing line 208 not the beam pointing line 202.

Hereinafter, a different value, e.g. A of the center of the radiation pattern 206 located at the beam pointing line 208 and the Θ axis is referred to as squint.

This squint is occurred due to affectation of an internal device in the antenna or an outside device, e.g. reflection plate, and is increased as the tilt of the beam is augmented as shown in FIG. 2.

In case that the squint does not have a value in a desired range, the radiation pattern radiated from the radiation device is not outputted in a desired direction. That is, it is difficult to control direction of the radiation pattern outputted from the radiation device.

### DISCLOSURE OF INVENTION

### Technical Problem

Accordingly, the present invention is provided to substantially obviate one or more problems due to limitations and disadvantages of the related art.

Example embodiment of the present invention provides an antenna for improving squint using radiation devices having different kinds.

### Technical Solution

An antenna of which squint is improved includes at least two radiation devices configured to have a beam pointing line, respectively. Here, kind of one or more of the radiation devices has different from that of the other radiation device.

The radiation devices include a first radiation device configured to have a first beam pointing line; and a second radiation device configured to have a second beam pointing line. Here, one of the beam pointing lines has positive slope, and the other beam pointing line has negative slope.

The slopes of the beam pointing lines have the same absolute values.

The first radiation device outputs +45° polarization and −45° polarization, and the second radiation device outputs +45° polarization and −45° polarization. Here, +45° polarization of the second radiation device compensates a beam pointing line of +45° polarization of the first radiation device, and −45° polarization of the second radiation device compensates a beam pointing line of −45° polarization of the first radiation device.

Squint of +45° polarization of the first radiation device increases in a positive direction, squint of −45° polarization of the first radiation device increases in a negative direction, squint of +45° polarization of the second radiation device increases in a negative direction, and squint of −45° polarization of the second radiation device increases a positive direction.

One or more of the radiation devices generates a single polarization.

A beam pointing line of one radiation device is compensated by sum of beam pointing lines of the other radiation devices.

The radiation devices include a first radiation device configured to generate a first radiation pattern using a vector composition method; and a second radiation device configured to generate a second radiation pattern using another method except the vector composition method.

An antenna of which squint is improved according to another example embodiment of the present invention includes a first radiation device configured to have a first beam pointing line having a positive slope; and a second radiation device configured to have a second beam pointing line having a negative slope. Here, a third beam pointing line generated by summing the first beam pointing line and the second beam pointing line has predetermined range of a slope

An antenna of which squint is improved according to still another example embodiment of the present invention includes a first radiation device; and a second radiation device. Here, kind of the second radiation device is substantially identical to that of the first radiation device, and a radiation pattern outputted from the second radiation device has phase difference by 180° from a radiation pattern outputted from the first radiation device.

The radiation devices generate the radiation pattern using a vector composition method.

An array antenna of which squint is improved according to one example embodiment of the present invention includes a first radiation device configured to include at least two sub-radiation devices having beam pointing lines; and a second radiation device configured to include at least two sub-radiation devices having beam pointing lines. Here, the sub-radiation devices are disposed in sequence, and kind of one of the sub-radiation devices in the first radiation device is different from that of the other sub-radiation device in the first radiation device.

A beam pointing line of one of the sub-radiation devices in the first radiation device is compensated by a beam pointing line of the other sub-radiation device.

A beam pointing line of one of the sub-radiation device in the first radiation device has positive slope, and the other sub-radiation device has negative slope.

A power provided to the first radiation device is different from that applied to the second radiation device.

A first power is applied to each of the sub-radiation devices in the first radiation device, and a second power is provided to each of the sub-radiation devices in the second radiation device.

A first sub-radiation device in the first radiation device outputs +45° polarization and −45° polarization, and a second sub-radiation device in the first radiation device outputs +45° polarization and −45° polarization. Here, +45° polarization of the second sub-radiation device compensates a beam pointing line of +45° polarization of the first sub-radiation device, and −45° polarization of the second sub-radiation device compensates a beam pointing line of −45° polarization of the first sub-radiation device.

The first radiation device includes a first sub-radiation device configured to generate a first radiation pattern using a vector composition method; and a second sub-radiation device configured to generate a second radiation pattern using another method except the vector composition method.

### ADVANTAGEOUS EFFECTS

An antenna of the present invention compensates a beam pointing line of a first radiation device using a beam pointing line of a second radiation device having kind different from the first radiation device, thereby improving squint of the antenna. It is desirable that the beam pointing line of the second radiation device has slope opposed to slope of the beam pointing line of the first radiation device on the basis of Θ axis.

An array antenna of the present invention includes radiation devices for improving squint by using sub-radiation devices, and thus a user may control a radiation pattern outputted from the array antenna in a desired direction.

### BRIEF DESCRIPTION OF THE DRAWINGS

Example embodiments of the present invention will become more apparent by describing in detail example embodiments of the present invention with reference to the accompanying drawings, in which:

FIG. 1 is a plan view illustrating a radiation device included in a common antenna;

FIG. 2 is a view illustrating squint occurred in the radiation device in FIG. 1;

FIG. 3 is a plan view illustrating an antenna for improving squint according to one example embodiment of the present invention;

FIG. 4 is a view illustrating a method of improving the squint in the antenna of FIG. 3;

FIG. 5 is a view illustrating a method of improving squint according to another example embodiment of the present invention;

FIG. 6 is a plan view illustrating an antenna according to another example embodiment of the present invention;

FIG. 7 is a view illustrating a method of improving squint in the antenna of FIG. 6; and

FIG. 8 is a plan view illustrating an array antenna according to one example embodiment of the present invention.

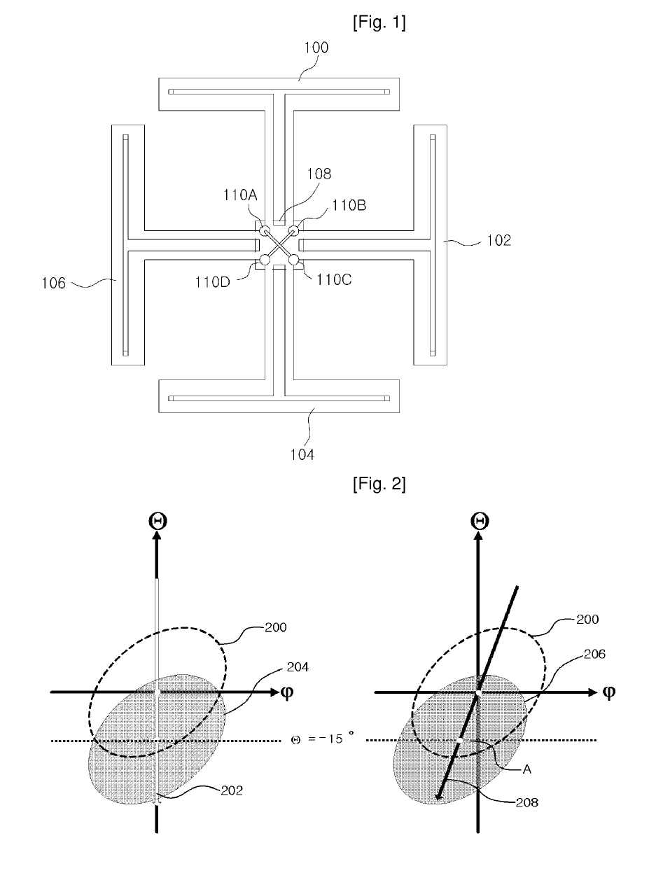

### MODE FOR THE INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

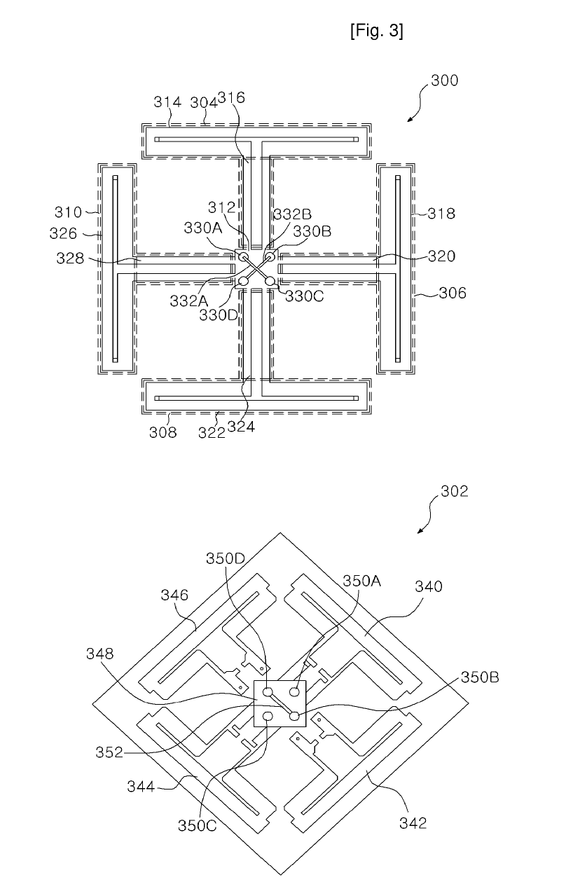

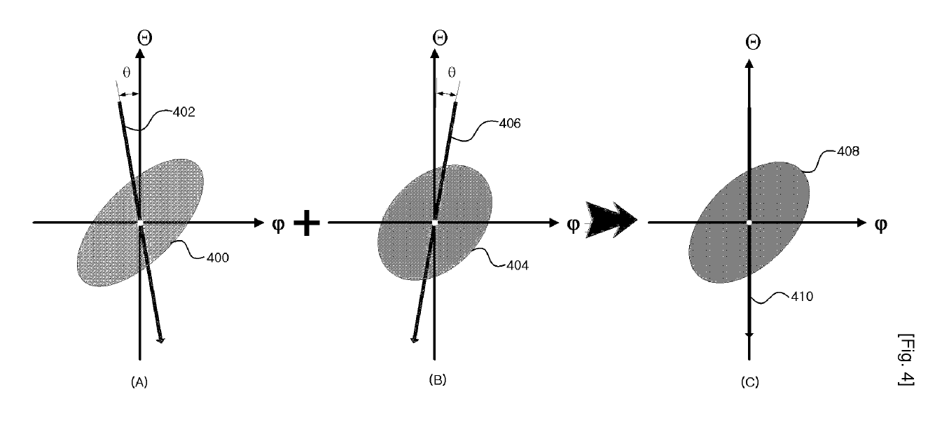

FIG. 3 is a plan view illustrating an antenna for improving squint according to one example embodiment of the present invention.

In FIG. 3, the antenna of the present embodiment improves squint, and includes a first radiation device 300 and a second radiation device 302. Here, the radiation devices 300 and 302 are disposed on a reflection plate (not shown).

The second radiation device 302 has kind different from the first radiation device 300, and so has a beam pointing line different from the first radiation device 300 as described below.

It is desirable that one of the beam pointing lines of the radiation devices 300 and 302 has positive slope, and the other beam pointing line has negative slope. In addition, the slopes of the beam pointing lines are the same absolute values.

That is, the radiation devices 300 and 302 may be embodied with various kinds of radiation devices as long as the radiation devices 300 and 302 have different kinds. On the other hand, it is assumed that the radiation device 300 uses a vector composition method and the radiation device 302 does not use the vector composition method as shown in FIG. 3 for convenient of description.

The first radiation device 300 includes dipole members 304, 306, 308 and 310 and a feeding section 312. In one example embodiment of the present invention, the dipole members 304, 306, 308 and 310 are folded dipole members, and are embodied with rectangular structure as shown in FIG. 3.

The feeding section 312 has a first feeding point 330A, a second feeding point 330B, a third feeding point 330C, a fourth feeding point 330D, a first connection line 332A and a second connection line 332B.

The first feeding point 330A is connected to the first dipole member 304 and a fourth dipole member 310, and provides current inputted from an outside device (not shown) to the first dipole member 304 and the fourth dipole member 310.

The second feeding point 330B is connected to the first dipole member 304 and the second dipole member 306, and provides current inputted from the outside device to the first dipole member 304 and the second dipole member 306.

The third feeding point 330C is connected to the second dipole member 306 and the third dipole member 308, and is connected to the first feeding point 330A through the first connection line 332A. Here, some of the current inputted to the first feeding point 330A is applied to the third feeding point 330C through the first connection line 332A.

The fourth feeding point 330D is connected to the third dipole member 308 and the fourth dipole member 310, and is connected to the second feeding point 330B through the second connection line 332B. Here, some of the current inputted to the second feeding point 330B is applied to the fourth feeding point 330D through the second connection line 332B.

In brief, in the antenna, the currents for a radiation pattern are inputted to only two feeding points 330A and 330B, and then are provided from the feeding points 330A and 330B to the other feeding points 330C and 330D through the connection lines 332A and 332B. That is, the antenna uses a feeding method biased in a specific direction.

The first dipole member 304 includes a first radiation member 314 and a first feeding line member 316, and is connected to the first feeding point 330A and the second feeding point 330B. Here, some of the current inputted to the first feeding point 330A is applied to the first radiation member 314 through the first feeding line member 316.

The second dipole member 306 is connected to the second feeding point 330B and the third feeding point 330C, and includes a second radiation member 318 and a second feeding line member 320. Here, some of the current inputted to the second feeding point 330B is applied to the second radiation member 318 through the second feeding line member 320.

The third dipole member 308 is connected to the third feeding point 330C and the fourth feeding point 330D, and includes a third radiation member 322 and a third feeding line member 324. Here, some of the current inputted to the first feeding point 330A is applied to the third radiation member 322 through the third feeding point 330C and the third feeding line member 324.

The fourth dipole member 310 is connected to the fourth feeding point 330D and the first feeding point 330A, and includes a fourth radiation member 326 and a fourth feeding line member 328. Here, some of the current inputted to the second feeding point 330B is applied to the fourth radiation member 326 through the fourth feeding point 330D and the fourth feeding line member 328.

In case that the current is inputted to the first feeding point 330A in the first radiation device 300, the current is passed to every dipole members 304, 306, 308 and 310 through the feeding points 330A and 330C. As a result, electric fields are generated by the current passing to the dipole members 304, 306, 308 and 310, and then the generated electric fields are vector-composed, and thus +45° polarization is outputted from the first radiation device 300.

In case that the current is inputted to the second feeding point 330B, the current is passed to every dipole members 304, 306, 308 and 310 through the feeding points 330B and 330D. As a result, electric fields are generated by the current passing to the dipole members 304, 306, 308 and 310, and then the generated electric fields are vector-composed, and thus −45° polarization is outputted from the first radiation device 300.

In short, the first radiation device 300 outputs dual polarization. Particularly, in the first radiation device 300, the currents inputted to the feeding points 330A and 330B are applied to the dipole members 304, 306, 308 and 310, and so the electric fields are generated from the dipole members 304, 306, 308 and 310. Then, the electric fields are vector-composed, and so +45° polarization and −45° polarization are generated. In other words, the first radiation device 300 outputs a radiation pattern using the vector composition method.

The second radiation device 302 includes dipole members 340, 342, 344 and 346 and a feeding section 348.

The feeding section 348 has feeding points 350A, 350B, 350C and 350D and a connection line 352.

The first feeding point 350A is connected to the fourth dipole member 346, and the second feeding point 350B is connected to the third dipole member 344.

The third feeding point 350C is connected to the second dipole member 342, and the fourth feeding point 350D is connected to the first dipole member 340.

In one example embodiment of the present invention, current is inputted to the first feeding point 350A, and then the inputted current is applied to the third feeding point 350C through a connection line (not shown) formed on a backside of the feeding section 348.

In addition, current is inputted to the fourth feeding point 350D, and then the inputted current is applied to the second feeding point 350B through the connection line 352 formed on a front side of the feeding section 348. In other words, the second radiation device 302 uses a feeding method biased in a specific direction.

The first dipole member 340 is connected to the fourth feeding point 350D, and the third dipole member 344 is connected to the second feeding point 350B. In this case, some of the current inputted to the fourth feeding point 350D is provided to the first dipole member 340, and the other current is applied to the third dipole member 344 through the second feeding point 350B. Hence, electric fields are generated from the first dipole member 340 and the third dipole member 344, and so +45° polarization is generated by the electric fields. Here, the second dipole member 342 and the fourth dipole member 346 do not affect to generation of +45° polarization.

The second dipole member 342 is connected to the third feeding point 350C, and the fourth dipole member 346 is connected to the first feeding point 350A. In this case, some of the current inputted to the first feeding point 350A is provided to the fourth dipole member 346, and the other current is applied to the second dipole member 342 through the third feeding point 350C. Hence, electric fields are generated from the second dipole member 342 and the fourth dipole member 346, and so −45° polarization is generated by the electric fields. Here, the first dipole member 340 and the third dipole member 344 do not affect to generation of −45° polarization.

That is, the second radiation device 302 generates +45° polarization and −45° polarization without using the vector composition method unlike the first radiation device 300.

In brief, the radiation devices 300 and 302 are radiation devices having different kinds for generating the polarizations through different method, and thus have different beam pointing lines as described below.

Hereinafter, a method of improving squint using the radiation devices 300 and 302 will be described in detail.

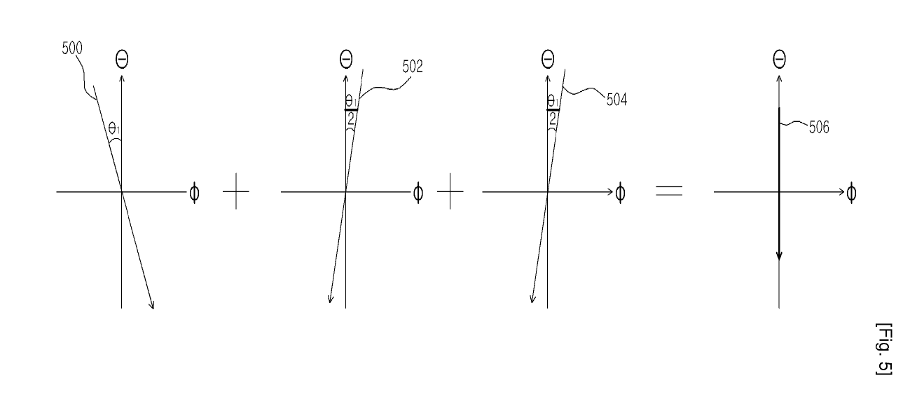

FIG. 4 is a view illustrating a method of improving the squint in the antenna of FIG. 3. Here, FIG. 4 shows only +45° polarization of dual polarization.

In (A) of FIG. 4, the first radiation device 300 outputs a first radiation pattern 400 when Θ is 0°. Here, a center of the first radiation pattern 400 is moved along a beam pointing line 402 as tilt of a beam radiated from the first radiation device 300 is changed, i.e. as Θ is changed. As a result, squint shown in FIG. 2 is occurred in the first radiation device 300. That is, the first radiation device 300 has a beam pointing line 402 having negative slope.

The second radiation device 302 outputs a second radiation pattern 404 when Θ is 0°. Here, a center of the second radiation pattern 404 is moved along a beam pointing line 406 as Θ is changed. In other words, the second radiation device 302 has a beam pointing line 406 having positive slope.

In brief, the radiation devices 300 and 302 having different kinds generate the beam pointing lines 402 and 406 having different slopes, wherein the slope of the beam pointing line 406 is preferably opposed to that of the beam pointing line 402. Here, since the radiation pattern of the antenna is generated by synthesizing the radiation patterns outputted from the radiation devices 300 and 302, a moving path of the generated radiation pattern, i.e. a beam pointing line 410 is generated by synthesizing the beam pointing lines 402 and 406 of the radiation devices 300 and 302.

Accordingly, since the second beam pointing line 406 has slope opposed to the first beam pointing line 402, the beam pointing line 410 is formed along the Θ axis as shown in (C) of FIG. 4. As a result, the squint corresponding to angle between the beam pointing line and the Θ axis is not occurred in the antenna. Hence, the antenna of the present embodiment may output desired radiation pattern.

In FIG. 4, the beam pointing lines 402 and 406 are symmetric on the basis of the Θ axis. However, the beam pointing lines 402 and 406 may be incompletely symmetric. Accordingly, the beam pointing line generated by synthesizing the beam pointing lines of the radiation devices 300 and 302 may be not in line with the Θ axis. In this case, the generated beam pointing line has slope smaller than the beam pointing lines of the radiation devices 300 and 302, wherein the slope of the generated beam pointing line is small. That is, certain squint is occurred, but the radiation devices 300 and 302 are properly set so that value of the squint is existed in a permission range of a user.

In short, in the antenna of the present embodiment, the squint is not occurred or has small value so that the value of the squint is existed in the permission range of the user.

Hereinafter, a method of improving the squint will be described through experimental embodiment in Table 1 and Table 2. Here, Table 1 shows the value of the squint in accordance with change of a tilt value of a beam in the first radiation device 300. Table 2 shows the value of the squint in accordance with change of a tilt value of a beam in the second radiation device 302.

TABLE 1

| | Frequency | | | | | |
|---|---|---|---|---|---|---|
| | 1.88 GHz | | 1.99 GHz | | 2.17 GHz | |
| | +45° | −45° | +45° | −45° | +45° | −45° |
| | po- | polar- | polar- | polar- | polar- | po- |
| Tilt value | larization | ization | ization | ization | ization | larization |
| 0° | −1.5 | +1.0 | −2.0 | +1.5 | −1.5 | +1.0 |
| −5° | −1.0 | +0.5 | −1.5 | +1.0 | −1.5 | +1.0 |
| −10° | −0.5 | 0.0 | −1.0 | +0.5 | −1.0 | +0.5 |
| −15° | +0.5 | −0.5 | −0.5 | 0.0 | −0.5 | 0.0 |

TABLE 2

| | Frequency | | | | | |
|---|---|---|---|---|---|---|
| | 1.88 GHz | | 1.99 GHz | | 2.17 GHz | |
| | +45° | −45° | +45° | −45° | +45° | −45° |
| | po- | polar- | polar- | polar- | polar- | po- |
| Tilt value | larization | ization | ization | ization | ization | larization |
| 0° | −0.5 | +0.5 | 0.0 | 0.0 | +0.5 | 0.0 |
| −5° | −0.5 | +0.5 | −1.0 | +1.0 | −1.5 | +1.5 |
| −10° | −1.0 | +1.0 | −2.0 | +2.0 | −3.0 | +3.0 |
| −15° | −1.0 | +1.0 | −3.0 | +3.0 | −4.5 | +4.0 |

As shown in Table 1 and Table 2, a value of the squint of +45° polarization in the first radiation device 300 increases in a positive direction as the tilt value of the beam augments in a negative direction. In other words, a beam pointing line of the +45° polarization has negative slope. In addition, a value of the squint of −45° polarization in the first radiation device 300 increases in a negative direction as the tilt value of the beam augments in a negative direction. That is, a beam pointing line of −45° polarization has positive slope.

A value of the squint of +45° polarization in the second radiation device 302 increases in a negative direction as the tilt value of the beam augments in a negative direction. In other words, a beam pointing line of the +45° polarization has positive slope. In addition, a value of the squint of −45° polarization in the second radiation device 302 increases in a positive direction as the tilt value of the beam augments in a negative direction. That is, a beam pointing line of −45° polarization has negative slope.

In +45° polarizations of the radiation devices 300 and 302, +45° polarization of the first radiation device 300 has negative slope, and +45° polarization of the second radiation device 302 has positive slope. Hence, the beam pointing line of a radiation pattern generated by synthesizing +45° polarizations is in line with the Θ axis or has absolute value slope smaller than +45° polarizations.

For example, in 1.88□, the generated radiation pattern has a squint value of −1.0° at the tilt 0°, and has a squint value of −0.75° at the tilt −5°. In addition, the generated radiation pattern has a squint value of −0.75° at the tilt −10°, and has a squint value of −0.25° at the tilt −15°. As a result, a beam pointing line of the generated radiation pattern has absolute value slope smaller than +45° polarizations of the radiation devices 300 and 302. In other words, the squint is improved.

On the other hand, since the beam pointing line of the radiation pattern is separated from the Θ axis, the beam pointing line should be come close to the Θ axis. In one example embodiment of the present invention, the antenna may close the beam pointing line to the Θ axis by changing a phase of current applied to the radiation devices 300 and 302.

In −45° polarization of the radiation devices 300 and 302, −45° polarization of the first radiation device 300 has positive slope, and −45° polarization of the second radiation device 302 has negative slope. Hence, the beam pointing line of a radiation pattern generated by synthesizing −45° polarizations is in line with the Θ axis or has absolute value slope smaller than −45° polarizations. As a result, squint of −45° polarization of the first radiation device 300 is improved by using −45° polarization of the second radiation device 302.

In brief, the antenna of the present embodiment compensates the beam pointing line of the first radiation device 300 using the beam pointing line of the second radiation device 302. Here, each of +45° polarization and −45° polarization is compensated. As a result, the beam pointing line of the antenna of the present embodiment may have excellent squint characteristic compared to that of the antenna in related art.

FIG. 5 is a view illustrating a method of improving squint according to another example embodiment of the present invention.

In FIG. 5, the antenna of the present embodiment has three radiation devices as one group, and improves squint using combination of the radiation devices. In particular, the antenna has a beam pointing line 506 generated by summing a beam pointing line 500 of the first radiation device, a beam pointing line 502 of the second radiation device and a beam pointing line 504 of the third radiation device. That is, the squint is improved in the antenna.

In short, the antenna of the present embodiment uses at least two radiation devices as shown in FIG. 4 and FIG. 5, thereby enhancing the squint characteristic of the radiation pattern outputted from the antenna. Here, kind of one or more of the radiation devices is different from that of the other radiation device.

The above antenna uses the beam pointing lines 502 and 504 having slopes (negative slope) opposed to the slope (positive slope) of the first beam pointing line 500 so as to compensate the first beam pointing line 500. However, in case of improving the squint using at least three beam pointing lines 500 to 504, one of the beam pointing lines 502 and 504 may have positive slope like the slope of the first beam pointing line 500.

In other words, one or more of beam pointing lines has a slope opposed to a slope of a specific beam pointing line so as to compensate the specific beam pointing line. However, other beam pointing line may have the same sign, e.g. positive slope as the specific beam pointing line as long as the squint is improved.

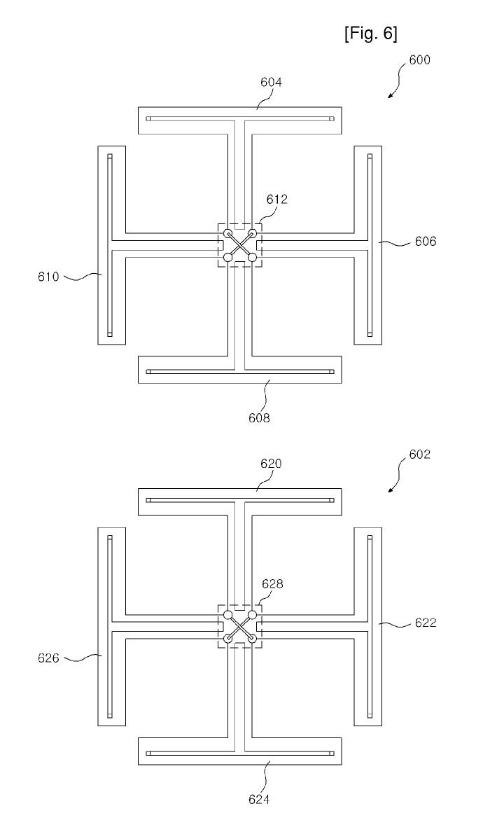

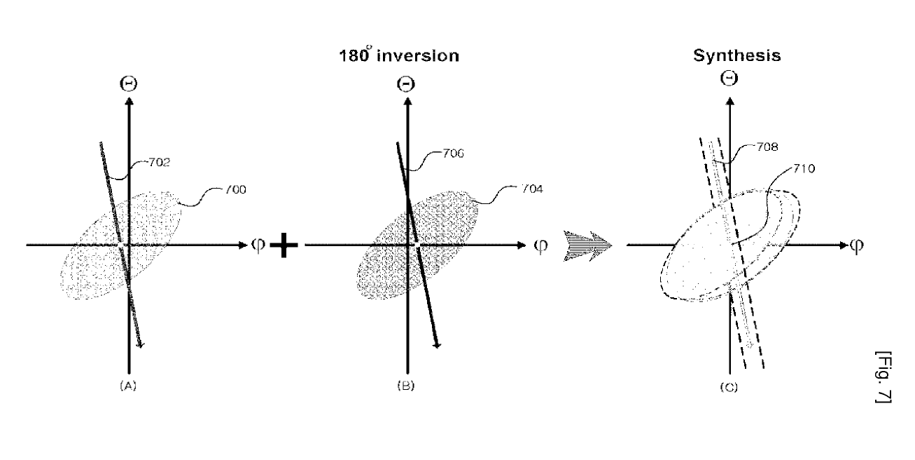

FIG. 6 is a plan view illustrating an antenna according to another example embodiment of the present invention. FIG. 7 is a view illustrating a method of improving squint in the antenna of FIG. 6.

In FIG. 6, a first radiation device 600 includes dipole devices 604, 606, 608 and 610 having rectangular structure and a feeding section 612. Here, the first dipole device 604 and the third dipole device 608 are disposed in a south-north direction, and the second dipole device 606 and the fourth dipole device 610 are disposed in an east-west direction.

The second radiation device 602 includes dipole members 620, 622, 624 and 626 having rectangular structure and a feeding section 628. Here, the first dipole device 620 and the third dipole device 624 are disposed in a south-north direction, and the second dipole device 622 and the fourth dipole device 628 are disposed in an east-west direction.

The first radiation device 600 and the second radiation device 602 use vector composition method. That is, the radiation devices 600 and 602 are the same kind of radiation devices.

Generally, in case that radiation devices are the same kind of radiation devices, beam pointing lines of the radiation devices have slopes having the same sign, and so squint is not improved.

However, current provided to the second radiation device 602 has phase difference by 180° from current applied to the first radiation device 600, a beam pointing line 706 of the second radiation device 602 is symmetrically disposed from a beam pointing line 702 of the first radiation device 600 on the basis of Θ axis.

That is, a squint value of the beam pointing line 706 when Θ is 0° has the same absolute value as that of the beam pointing line 702 when Θ is 0°, wherein the squint value of the beam pointing line 706 has different sign from that of the beam pointing line 702. Accordingly, a squint value of the antenna equals to 0° when Θ is 0°, i.e. the squint of the antenna is improved. However, since a beam pointing line 708 is formed by synthesizing the beam pointing lines 702 and 706, the squint of the antenna is not improved at angles except 0° shown in FIG. 7(C).

Accordingly, in case that the antenna uses only the radiation pattern when tilt of a beam radiated from the antenna is 0°, i.e. Θ is 0°, the squint of the antenna may be improved by using the radiation devices 600 and 602 having phase difference of about 180°.

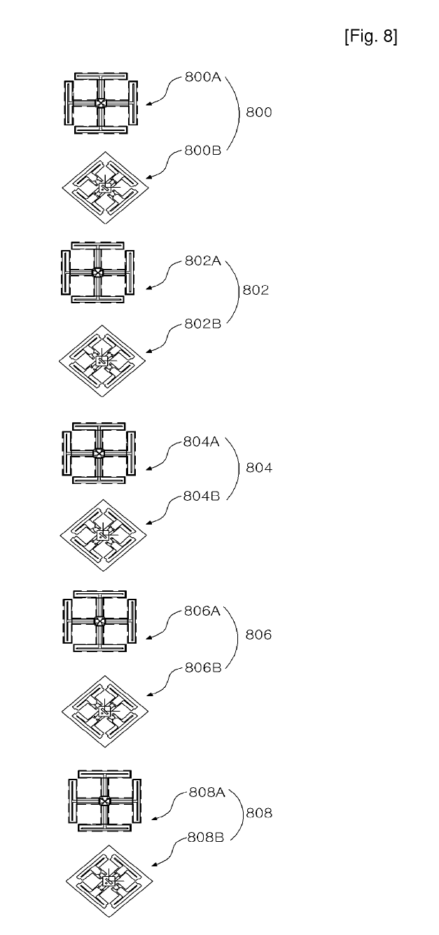

FIG. 8 is a plan view illustrating an array antenna according to one example embodiment of the present invention.

In FIG. 8, the array antenna of the present embodiment includes a first radiation device 800, a second radiation device 802, a third radiation device 804, a fourth radiation device 806 and a fifth radiation device 808, and outputs a radiation pattern in a given direction by using the radiation devices 800, 802, 804, 806 and 808. Here, the radiation devices 800, 802, 804, 806 and 808 are disposed in sequence on a reflection plate (not shown).

The first radiation device 800 includes a first sub-radiation device 800A and a second sub-radiation device 800B. Here, the second sub-radiation device 800B compensates a beam pointing line of the first sub-radiation device 800A as described in the above embodiments, thereby improving squint of the first radiation device 800.

Like the first radiation device 800, squints of the radiation devices 802, 804, 806 and 808 are improved.

In other words, at least one of the radiation devices 800, 802, 804, 806 and 808 has sub-radiation devices having different kinds so that squint is improved.

It is desirable that every radiation devices 800, 802, 804, 806 and 808 improves squint using sub-radiation devices having different kinds.

In the array antenna, powers applied to the radiation devices 800, 802, 804, 806 and 808 have different magnitude. In another example embodiment of the present invention, some of the powers may have the same magnitude.

On the other hand, it is desirable that powers applied to the sub-radiation devices included in one radiation device have the same magnitude considering the squint of the radiation device.

FIG. 8 shows only two sub-radiation devices in one radiation device. However, one radiation device may have at least three sub-radiation devices. That is, one radiation device may have at least two sub-radiation devices as long as the squint of the radiation device is improved.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An antenna of which squint is improved, the antenna comprising:
at least two radiation devices configured to have a beam pointing line, respectively,
wherein kind of one or more of the radiation devices has different from that of the other radiation device.

2. The antenna of claim 1, wherein the radiation devices include:
a first radiation device configured to have a first beam pointing line; and
a second radiation device configured to have a second beam pointing line,
wherein one of the beam pointing lines has positive slope, and the other beam pointing line has negative slope.

3. The antenna of claim 2, wherein the slopes of the beam pointing lines have the same absolute values

4. The antenna of claim 1, wherein the first radiation device outputs +45° polarization and −45° polarization, and the second radiation device outputs +45° polarization and −45° polarization,
wherein +45° polarization of the second radiation device compensates a beam pointing line of +45° polarization of the first radiation device, and −45° polarization of the second radiation device compensates a beam pointing line of −45° polarization of the first radiation device.

5. The antenna of claim 4, wherein squint of +45° polarization of the first radiation device increases in a positive direction, squint of −45° polarization of the first radiation device increases in a negative direction, squint of +45° polarization of the second radiation device increases in a negative direction, and squint of −45° polarization of the second radiation device increases a positive direction.

6. The antenna of claim 1, wherein one or more of the radiation devices generates a single polarization.

7. The antenna of claim 1, wherein a beam pointing line of one radiation device is compensated by sum of beam pointing lines of the other radiation devices.

8. The antenna of claim 1, wherein the radiation devices include:
a first radiation device configured to generate a first radiation pattern using a vector composition method; and
a second radiation device configured to generate a second radiation pattern using another method except the vector composition method.

9. An antenna of which squint is improved, the antenna comprising:
a first radiation device configured to have a first beam pointing line having a positive slope; and
a second radiation device configured to have a second beam pointing line having a negative slope,
wherein a third beam pointing line generated by summing the first beam pointing line and the second beam pointing line has predetermined range of a slope

10. An antenna of which squint is improved, the antenna comprising:
a first radiation device; and
a second radiation device,
wherein kind of the second radiation device is substantially identical to that of the first radiation device, and a radiation pattern outputted from the second radiation device has phase difference by 180° from a radiation pattern outputted from the first radiation device.

11. The antenna of claim 10, wherein the radiation devices generate the radiation pattern using a vector composition method.

12. An array antenna of which squint is improved, the antenna comprising:
a first radiation device configured to include at least two sub-radiation devices having beam pointing lines; and
a second radiation device configured to include at least two sub-radiation devices having beam pointing lines,
wherein the sub-radiation devices are disposed in sequence, and kind of one of the sub-radiation devices in the first radiation device is different from that of the other sub-radiation device in the first radiation device.

13. The array antenna of claim 12, wherein a beam pointing line of one of the sub-radiation devices in the first radiation device is compensated by a beam pointing line of the other sub-radiation device.

14. The array antenna of claim 13, wherein a beam pointing line of one of the sub-radiation device in the first radiation device has positive slope, and the other sub-radiation device has negative slope.

15. The array antenna of claim 12, wherein a power provided to the first radiation device is different from that applied to the second radiation device.

16. The array antenna of claim 12, wherein a first power is applied to each of the sub-radiation devices in the first radiation device, and a second power is provided to each of the sub-radiation devices in the second radiation device.

17. The array antenna of claim 12, wherein a first sub-radiation device in the first radiation device outputs +45° polarization and −45° polarization, and a second sub-radiation device in the first radiation device outputs +45° polarization and −45° polarization,
and wherein +45° polarization of the second sub-radiation device compensates a beam pointing line of +45° polarization of the first sub-radiation device, and −45° polarization of the second sub-radiation device compensates a beam pointing line of −45° polarization of the first sub-radiation device.

18. The array antenna of claim 12, wherein the first radiation device includes:
a first sub-radiation device configured to generate a first radiation pattern using a vector composition method; and
a second sub-radiation device configured to generate a second radiation pattern using another method except the vector composition method.
